(19) United States
(12) Patent Application Publication
(10) Pub. No.: US 2004/0007626 A1
(43) Pub. Date: Jan. 15, 2004

(54) Article identification system

(76) Inventor: Steven Alan Wolfowitz, Sandton (ZA)

Correspondence Address: YOUNG & THOMPSON, 745 SOUTH 23RD STREET 2ND FLOOR, ARLINGTON, VA, 22202

(21) Appl. No.: 10/311,001

(22) PCT Filed: Jun. 7, 2001
(86) PCT No.: PCT/ZA01/00075

(30) Foreign Application Priority Data
Jun. 12, 2000 (ZA) 2000/2934

(51) Int. Cl. G06K 19/06

(52) U.S. Cl. 235/491

(57) ABSTRACT

A mixture of isotopes is provided which may be embedded into an article such as a motor vehicle, software or other articles so that they may be detected by a Geiger counter or other emission detector for identification purposes as well as to provide a chronological record of the article according to the half-lives of the isotopes chosen for the mixture. The isotopes should be chosen having regard to half-lives of the order of time of the life of the article.

### TECHNICAL FIELD OF THE INVENTION

This invention relates to an article or personal identification system and in particular a motor vehicle identification system.

### BACKGROUND OF THE INVENTION

Crime and in particular fraud and theft are continually on the increase.

Modern technology has provided innovative new ways of conducting business using computers, the Internet and wireless communications which should benefit the end user in terms of cost and efficiency. However these advancements are being hampered by the inability to ensure the financial privacy and security of the transacting parties.

Current identification technology including the latest iris and fingerprint electronic identifications is unable to prevent access to information by high tech criminals who are able to reproduce these forms of identification, re-program smart-cards, reproduce the most complex holograms and encryption technology used to protect compact discs and credit cards.

A more traditional form of theft is that of motor vehicles.

Thieves usually try to change the identity of the vehicle to avoid detection. This could be by altering the colour, or the engine and chassis identification numbers and markings. Frequently the vehicle is able to be reregistered thereafter and not recovered. The benefit to the thief is the ability to sell the car in this condition at its market price. Frequently corrupt officials aid in this process because the system is highly lucrative and there are sufficient funds for wide networks to be compensated.

Current systems of identification of the vehicle are inadequate as they can be easily changed or removed. If this happens and the vehicle is presented at licensing authorities for registration the officials are able to proclaim that the vehicles are not stolen as they are not traceable within their listings of stolen vehicles. The stolen vehicle can thus be reregistered as unstolen and sold at a high price.

It is therefore an object of this invention to provide a permanent means of identifying an article which is unalterable and which cannot be duplicated.

The Applicant believes that this is achievable with the assistance of isotopes.

The electromagnetic spectrum classifies types of energy according to ranges of frequencies and wavelengths. Radio waves, x-rays, ultraviolet rays, infra-red waves, visible radiation and microwaves have all been applied to various everyday appliances and systems. The last classification, gamma rays are emitted by isotopes which can be incorporated in everyday standard technologies.

Atoms of elements consist mainly of protons, neutrons and electrons. Isotopes are forms of elements containing the same number of protons but different numbers of neutrons. These try to revert to their usual state by emitting radiation which is different to radio waves.

Isotopes emitting safe radiation are being manufactured for specific uses every day. This has been for many years in the medical field, etc. carbon 14 (a naturally occurring isotope in bones) decays over a long period progressively to become carbon 12 (the natural isotope). By measuring the radiation now we are able to date age over thousands of years because we know the ‘half-life’ or ‘decay-rate’ of this isotope. Our bodies all contain an isotope of potassium which emits safe radiation all our lives.

The invention comprises, at a basic level, of establishing a database of events linked to isotope emission values at the time that the events occur.

In this specification the term incorporated may be taken to mean to incorporate either during or after manufacture of the article. Thus the incorporation could take place on a molecular level, or by the inclusion of a discrete unit or device.

### THE INVENTION

According to the invention, an article identification means is adapted to emit one or more radiations;

the means having an initial and determinable potential/s for emission/s;

the emission/s occurring at a predetermined rate/s;

the means being incorporated into and/or permanently affixed to the article;

the means being measurable to record the initial emission/s and store the emission/s on a database;

the initial reading relating to specific identification data relating to the article, and each subsequent reading relating to chronological events occurring during the lifespan of the article to establish a unique and verifiable historical database of events;

and a processing unit for comparing the readings and predicted readings for the events.

In the preferred form of the invention, the rate of emission cannot be altered.

In the preferred form of the invention, the means comprises a predetermined quantity of one or more radioactive isotope(s) of a chemical element, the isotope(s) being incorporated into and/or permanently affixed to the article.

In the preferred form of the invention, the isotope has a half-life commensurate with the period for which the article must remain identifiable.

In one form, a plurality of isotopes having different half lives is provided. In this way many different combinations may be provided to give each article a uniquely identifiable potential for emission at a given time. The result is that each device (isotope) functions as a non-resettable chemical clock which follows the lifespan of the article. Identification is possible by logging its dynamic characteristics (emission data) initially to its static data and subsequently to its dynamic data at ensuing times.

In one form of the invention as applied to vehicles, including vehicle chassis and/or engines, the isotope may be embedded within the chassis and/or the engine, preferably both. In this form of the invention, the isotope may have a half-life of the order of, for example, two years.

The method of identification of this invention may be used in combination with a computerised system for logging the initial activity of the isotope and tracking it as the ownership of the vehicle is transferred. At each transfer of distribution and/or ownership, the activity of the isotope may be measured and recorded together with details of the event transaction and with the standard identification marks of the article, and in particular, a motor vehicle. This would provide a complete database for the vehicles.

In one form of the invention, measurement of the radiation or emission is preferably by means of a portable or hand-held apparatus, for example a palm top computer, wireless application protocol (WAP) device, cellular telephone or the like, suitably modified for this purpose. The modification may involve the inclusion of a geiger counter or other suitable energy measuring device. The measuring device may be further adapted to transmit measurements to a database for verification, up-date or enquiry purposes, and receive feedback from the database, for example correlation or comparison with standard identification marks on the article and the current emission value. The communication may take place by means of the internet.

In the preferred form of the invention, the radiation emitted by the isotope should be at a low level which is not harmful to human beings.

Whilst the uses of the device are particularly suited to the identification of motor vehicles, it is suggested in the specification that further uses could include the tagging or finger printing of goods in the prevention of counterfeiting including copying of software and musical compact discs and credit cards or personal identification cards, passports, etc.

Examples of Applications

Software and Music Compact Discs and Personal Identity Discs

A mixture or cocktail of isotopes may be included into CD ROM software (for example MS Windows), the emission strength of each of the isotopes being linked to the serial number of the disc at the time of manufacture. The strength may be measured at times of manufacture, distribution and sale and may be stored, thereby establishing a history of the transactions and (or) occurrences. Each disc would then have its own distinct identity.

Furthermore, a computer may be provided with an emission reader adapted to positively identify a software disc. This could then be E-mailed back to the supplier or manufacturer with the serial number and any other relevant information. The supplier or manufacturer could then verify the genuineness of the disc in the computer and license its content for use in the computer. If each computer also had an isotope implanted in it, it too could then acquire its own signature. Legislation could be introduced for each computer and its user to have to transmit its signature information to its service provider before it is permitted to log on the Internet. Any unauthorised entry in to a computer could then be traced. The sender of messages through the Internet could then also be traced. Any unauthorized transmission of viruses or ‘bugs’ or ‘hacking’ could then be traced absolutely. Safe absolutely positive electronic communications between parties can be effected between two parties identified in this way.

Financial Transactions

Another important use of the invention relates to credit cards. One or more isotopes or mixtures thereof may be incorporated into credit cards at the time of manufacture and/or distribution, thereby ensuring ownership. If such tagged credit cards were read into a computer, or ATM, etc., fitted with its emission reader, the identity of the credit card owner could also be ensured, for example, for E-commercial transactions, thereby enhancing the security and integrity of the transactions. This would also prevent application of credit cards and CD ROMs and the like.

In like fashion, a ‘credit card’ could be adapted to contain a digitized fingerprint and/or digitized iris scan, and/or photograph, etc., together with an isotope/mixture. The ownership of the card could be ensured by the inability to reproduce the card with its database of transactions/events linked to its emission readings. The ‘credit card’ would effectively become a personal identity card associated with the person it identifies. If detailed events concerning health and financial and other personal issues were recorded in the database the card could serve as a complete personal identification history and could be used for the activation of many diverse services.

Motor Vehicles

A motor car of a particular model and colour may be manufactured at a particular factory. The emission level of a minute quantity of an isotope, or mixture of isotopes, incorporated in its engine may be noted together with the car details. It may then be transferred on a particular date to a particular dealer in a particular country and the decreased isotope emission may be again noted at that date. At later dates it is sold to various owners and at each the emission is noted and recorded. These records may be kept in existing and/or other electronic databases and accessed via the Internet. They positively identify the vehicle and its ownership.

The exact decay time profile and history of events cannot be duplicated. The vehicle would not be able to be sold without verification of its ownership and the transaction would also be logged to ensure that the new owner would be able to sell the vehicle later at its market price and verify positively that it was not a stolen vehicle. If the engine were changed without recording the transaction, the vehicle would lose its resale value. The same would happen if the isotope was removed by a thief. Vehicles would not be high-jacked if they could not be sold at market prices.

### EXAMPLES OF THE INVENTION

1. Motor Car Engines

A motor car engine may be cast to incorporate in an externally accessible position a cylindrical small hole to receive a dose of an isotope after assembly of the car or manufacture of the engine. The surface hole of this cylindrical hole may be plugged or welded closed.

The gamma ray energy emission will be proportional to the quantity of isotope inserted in the cylindrical compartment and this energy can be measured at any time by placing a suitable geiger counter at the position of the chamber.

If differing quantities of isotope are inserted in subsequent engines, their energy emission will be different from one another as measured by the geiger counter. By measuring the emission strengths at two different times the exponential mathematical curve describing the emission strengths at ensuing times can be determined.

It would also be possible to insert differing amounts of two or more different isotopes into the chamber to provide differing energy decay patterns for each engine if required.

2. Credit Cards

Small amounts of isotopes may be implanted into standard or other types of credit cards. The isotope may be attracted statically to a steel pinpointed probe which may be heated and impressed into the card at a specified point. By melting the plastic of the card at that point the isotope could be melted into the plastic of the card.

The isotope could originally be dispersed into a resin medium which could also be melted into the card in a similar manner.

3. Artworks, Other Articles

A small amount of isotope, which may be dispersed in a fine resin powder, may be inserted into the articles at a predetermined position, by heated implantation, into drilled cavity, etc.

4. Livestock

Isotopes may be implanted into small holes drilled into cattle hooves which may be plugged by epoxy or other resins. These may be used to develop a history of the ownership of the animal and prevent rustling, etc.

The isotopes may be encapsulated, for example in titanium tubes of less than 0.5 mm diameter and these tubes may be used for the above and other applications.

Emission Readings

Energy radiation of isotopes implanted can be read by Geiger counters and an array of other gamma ray energy readers. Some of these are adapted to measure wavelengths and others measure frequencies and other energy levels.

The atmosphere contains ambient radiation including gamma rays. These must be screened from the reader when measuring the emissions from the isotopes. Traditionally lead has been used to absorb unwanted radiation but nowadays ceramics have been developed which do this job more effectively using much smaller quantities of absorbtive material.

The Geiger counter, adapted in size for the particular purpose, may be shielded from normal radiation by means of being encased partially or filly as required by these materials.

Incorporation in Current Application Architecture

The radiation emitted by isotopes embedded in articles or materials can easily be converted and integrated into everyday circuitry of everyday applications.

For example, an ATM machine may be altered to incorporate a small Geiger counter positioned to read the emissivity of the isotope (or mixture of isotopes) imbedded in the credit card at a corresponding position. When a card is inserted information would be read from the magnetic stripe and/or the ‘smart card’ radio frequency chip, and also the isotope. All this information could be channelled to the organisation's computerised database for verification of the card's history before the transaction could be processed.

For a motor car engine, a Geiger counter may be incorporated in a cellphone or digital PDA which could access the internet and thereby the database of the verifying authority.

History

The crux of the process of the present invention is the development of a record, in a database or the like of a series of information linking the static information (serial number, name, address, colour, etc) of the article—or person—with the dynamic isotope emission value measured at the same time that the static information was recorded and linking of ensuing details of events/transactions with emission values at the times of these ensuing events/transactions.

The differing histories, which can be accessed for verification etc., provide the absolute identity of the article or person, etc.

1. An article identification means which emits one or more radiations, characterised in that:
the means has an initial and determinable potential/s for emission/s;
the emission/s occurring at a predetermined rate/s;
the means being incorporated into and/or permanently affixed to the article;
the means being measurable to record the initial emission/s and store the emission/s on a database;
the initial reading relating to specific identification data relating to the article, and each subsequent reading relating to chronological events occurring during the lifespan of the article to establish a unique and verifiable historical database of events;
and a processing unit for comparing the readings and predicted readings for the events.

2. The means according to claim 1 characterised in that the rate of emission cannot be altered.

3. The means according to either of the above claims characterised in that the means comprises a predetermined quantity of one or more radioactive isotope(s) of a chemical element, the isotope(s) being incorporated into and/or permanently affixed to the article.

4. The means according to claim 3 characterised in that the isotope has a half-life commensurate with the period for which the article must remain identifiable.

5. The means according to claim 4 characterised in that a plurality of isotopes having different half-lives is provided for establishment of a large variety of combinations for each article to have a uniquely identifiable potential for emission at a given time.

6. The means according to any of the above claims characterised in that the means is applied to the chassis and/or engine of a motor vehicle; or to software, credit cards, artworks, livestock and others.

7. A device for measuring and recording the emission/s of the means characterised in a reading device and a computerised device for receiving information from the reading device.
